(19) United States
(12) Patent Application Publication
(10) Pub. No.: US 2015/0270958 A1
(43) Pub. Date: Sep. 24, 2015

(54) DECRYPTABLE INDEX GENERATION METHOD FOR RANGE SEARCH, SEARCH METHOD, AND DECRYPTION METHOD

(71) Applicant: Electronics and Telecommunications Research Institute, Daejeon (KR)

(72) Inventors: Nam-Su JHO, Daejeon (KR); Ku-Young CHANG, Daejeon (KR); Taek-Young YOUN, Daejeon (KR); Sung-Kyong UN, Daejeon (KR)

(21) Appl. No.: 14/662,126

(22) Filed: Mar. 18, 2015

(30) Foreign Application Priority Data
Mar. 18, 2014 (KR) 10-2014-0031371

(51) Int. Cl. H04L 9/08; G06F 17/30

(52) U.S. Cl. CPC H04L 9/0822; G06F 17/30321; H04L 2209/24

(57) ABSTRACT

Disclosed herein are a method that generates an index for an efficient range search in an encrypted DB, and a decryption apparatus and method that are capable of searching for desired data and decrypting search results using the index generation method. The presented index generation method includes preparing a private key and a one-way function, calculating a tag for an input plaintext interval using the private key and the one-way function, and dividing the plaintext interval into a plurality of partial intervals, encrypting information of a partial interval including plaintext using the tag, and then generating an encrypted index.

### CROSS REFERENCE TO RELATED APPLICATION

This application claims the benefit of Korean Patent Application No. 10-2014-0031371 filed Mar. 18, 2014, which is hereby incorporated by reference in its entirety into this application.

### BACKGROUND OF THE INVENTION

1. Technical Field

The present invention generally relates to a decryptable index generation method for a range search, a search method, and a decryption method and, more particularly, to a method that generates an efficient index for a range search in an encrypted database (DB), a search method that obtains search results using the index generation method, and a method that decrypts the search results.

2. Description of the Related Art

With the advancement of information use in modern information society, the amount of data that is managed/processed by individuals and businesses has increased. With the wide popularization of smart devices, the range of various information services has also greatly increased.

However, it is difficult for all members constituting an information society to personally maintain a system for managing such information. Accordingly, cases where information is managed and services are offered using an external DB service, such as a cloud service, have gradually increased.

However, for methods of entrusting an external DB with personal data, instances of the leakage of private personal information through an external DB have also increased, and thus a solution to the provision of data privacy has emerged as a very important issue.

Although various solutions have been presented, it is very difficult to simultaneously satisfy data privacy and efficiency, and research into various techniques has been conducted to date.

Among various techniques, methods presented based on high security include a method of encrypting data and storing the encrypted data in a DB.

A long-used encryption system that has been a basis for information protection guarantees the security of ciphertext. However, a DB is generally configured such that searching for data and the utilization of found data in addition to the storage of data are very important, but there is a disadvantage in that encrypted data prevents a DB server from obtaining any information from the encrypted data, thus fundamentally blocking additional functions.

In order to solve this disadvantage, research into various technologies in multiple fields ranging from the most basic problem of efficiently searching an encrypted DB for data to the performance of a desired operation without decrypting encrypted data has been actively conducted. Among these technologies, range search technology is technology for simultaneously searching a DB for all data falling within a user's desired range. Since searching for various types of data is possible based on such a range search, range search technology may be regarded as a very important issue. More specifically, a range search denotes an operation of simultaneously searching a given interval [a, b] for all data including a keyword x satisfying a<x<b.

As related preceding technology, U.S. Patent Application Publication No. 2005-0147246 (entitled “System and Method for Fast Querying of Encrypted Databases”) discloses technology that can perform equality and range queries, the aggregation operations of MAX, MIN, and COUNT, as well as GROUPBY and ORDERBY operations, directly on encrypted data without decrypting operands.

### SUMMARY OF THE INVENTION

Accordingly, the present invention has been made keeping in mind the above problems occurring in the prior art, and an object of the present invention is to provide a method that generates an index for an efficient range search in an encrypted DB.

Another object of the present invention is to provide a search method that searches for desired data and obtains search results using the above-described index generation method.

A further object of the present invention is to provide a decryption method that is capable of decrypting search results.

In accordance with an aspect of the present invention to accomplish the above objects, there is provided a decryptable index generation method for a range search, including generating, by an index generation unit, a tag using a one-way function by receiving information of a interval, in which plaintext is included, and a private key as inputs; and dividing, by the index generation unit, the interval in which the plaintext is included into a plurality of partial intervals, encrypting information of a partial interval, in which the plaintext is included, by means of the tag, and generating an encrypted index.

Generating the tag may include receiving the private key and the one-way function prepared by an advance preparation unit; and for the interval in which the plaintext is included, calculating the tag using both the private key and the one-way function.

Generating the encrypted index may include dividing the interval in which the plaintext is included into the plurality of partial intervals; detecting the partial interval, in which the plaintext is included, from the plurality of partial intervals; and generating the encrypted index by encrypting information of the partial interval, in which the plaintext is included, using the tag.

Dividing the interval into the plurality of partial intervals may be configured to enable a interval division ratio to be randomly adjusted.

Generating the encrypted index may be repeated a number of times corresponding to a bit length of the plaintext.

A range search and a decryption operation may be enabled using the encrypted index.

Generating the encrypted index may include generating a search index shorter than a bit length of the plaintext and providing separate encrypted data, without completing repetitive index generation a number of times corresponding to a bit length of the plaintext.

Generating the tag may be configured to generate the tag at a size of one or more bits.

The encrypted index may be transmitted to and stored in any one of an additional computer, an additional database server, and an additional storage device, none of which are managed by a user.

In accordance with another aspect of the present invention to accomplish the above objects, there is provided a search method, including receiving and storing, by a search unit, an encrypted index; receiving, by the search unit, a trapdoor generated from a desired search interval using a private key and a one-way function that are used to generate the encrypted index; and performing, by the search unit, a search by comparing the trapdoor with the encrypted index.

The trapdoor may be generated based on tags, wherein the tags are generated in such a way that generation of the tags starts at an entire plaintext interval, is performed while the entire plaintext interval is divided, and is repeated until a interval obtained from division is identical to the range search interval.

Performing the search may include comparing the trapdoor with the encrypted index, and providing an index, an upper bit string of which is identical to a bit string of the trapdoor, as search results.

Performing the search may be performed by any one of an additional computer, an additional database server, and an additional storage device, none of which are managed by a user.

In accordance with a further aspect of the present invention to accomplish the above objects, there is provided a decryption method, including receiving, by a decryption unit, an encrypted index; generating, by the decryption unit, a tag for each plaintext interval using a private key and a one-way function that are used to generate the encrypted index; and reconstructing, by the decryption unit, plaintext by comparing the encrypted index with the tag and by specifying a partial interval in which the plaintext is included.

Reconstructing the plaintext may include reconstructing the plaintext into plaintext information by repeating a procedure of dividing a plaintext interval based on information generated from the encrypted index and the one-way function and of estimating a location of the plaintext from intervals obtained from division.

Reconstructing the plaintext may further include repeating interval division a number of times corresponding to a bit length of the plaintext, upon dividing the plaintext interval.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an index generation apparatus, a search apparatus, and a decryption apparatus according to an embodiment of the present invention;

FIG. 2 is a flowchart showing an index generation method, a search method, and a decryption method according to an embodiment of the present invention;

FIG. 3 is a flowchart showing in detail an index generation step shown in FIG. 2; and

FIG. 4 is an embodiment of the present invention implemented in a computer system.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

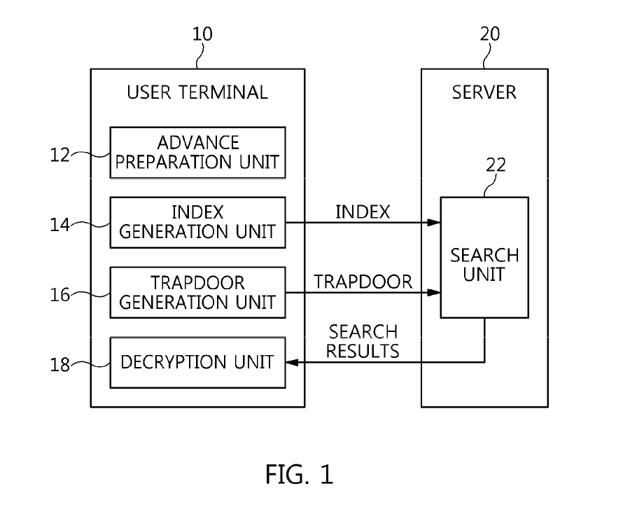

FIG. 1 is a diagram showing an index generation apparatus, a search apparatus, and a decryption apparatus according to an embodiment of the present invention.

In FIG. 1, the advance preparation unit 12 and the index generation unit 14 of a user terminal 10 are components required to implement an index generation apparatus according to an embodiment of the present invention.

Further, in FIG. 1, the search unit 22 of a server 20 may be a search apparatus. The search unit 22 receives a trapdoor from a trapdoor generation unit 16 provided in the user terminal 10 so as to perform a search.

Meanwhile, in FIG. 1, the decryption unit 18 of the user terminal 10 may be a decryption apparatus.

In the following description, the number of items stored by a user in the server 20 is defined as N, and a keyword included in each item is an integer value between 1 and R (because all keywords may be consequently regarded as bit strings, each having a predetermined length). For convenience of description, it is assumed that, for a specific integer d, R=2^{d} is satisfied.

In FIG. 1, the advance preparation unit 12 prepares a private key and a one-way function that are required by the corresponding user terminal 10. In other words, the advance preparation unit 12 determines the user's λ-bit private key k and cryptographically secure one-way function f: {0,1}^{λ}×{0,1}^{d}×{0,1}^{d}♯{0,1}. Further, the advance preparation unit 12 stores the private key k and the one-way function f as the private information of the user terminal 10.

The index generation unit 14 generates an encrypted index for a future range search upon encrypting data. In other words, the index generation unit 14 calculates a 1-bit tag using the private key and the cryptographic one-way function f of the advance preparation unit 12 for a given entire plaintext interval, and thereafter divides the given entire plaintext interval into two partial intervals having the same size, generates an encrypted index (1-bit index) depending on the location of a partial interval, in which plaintext m is included, of the two partial intervals, and repeats a tag generation procedure and an encrypted index generation procedure using the private key and the cryptographic one-way function f of the advance preparation unit 12.

That is, the index generation unit 14 repeats a procedure of generating a 1-bit tag using the cryptographic one-way function f for a given plaintext interval, dividing the given plaintext interval into two partial intervals, and generating a 1-bit encrypted index using the tag depending on the location at which the plaintext m is included, wherein such a procedure starts at the entire plaintext interval (space) and is repeated until a partial interval (space) including only the plaintext m remains. Each encrypted index generated in this way may simultaneously function both as an index for a range search and as ciphertext.

The index generation unit 14 transmits a finally generated encrypted index to the server 20, and the server 20 stores the received encrypted index.

Meanwhile, the index generation unit 14 may randomly adjust a interval division ratio.

Further, the index generation unit 14 may generate a short index without repeating the division of partial intervals a number of times corresponding to the bit length of plaintext. In this case, the index generation unit 14 may provide separate encrypted data to the server 20 to decrypt the data, instead of generating a short search index by adjusting the length of an index.

Although the embodiment of the present invention is configured such that the encrypted index generated by the index generation unit 14 is transmitted to and stored in the search unit 22 of the server 20 (this may be regarded as a DB server), the encrypted index may be transmitted to and stored in an additional computer or additional storage device (e.g., a Universal Serial Bus (USB) storage device or the like) that is not managed by the user (data owner).

The trapdoor generation unit 16 generates a trapdoor corresponding to a desired search range. That is, the trapdoor generation unit 16 generates a trapdoor for a search from the search range desired by the user.

The trapdoor generation unit 16 performs a tag generation procedure from the entire plaintext interval using the private key and the cryptographic one-way function f of the advance preparation unit 12. Here, a partial interval including a desired search interval is selected from among partial intervals obtained from division. Per division procedure, a 1-bit tag is generated. This procedure is repeated to generate tags to the desired search interval, and all tags are connected to constitute a trapdoor. The trapdoor generation unit 16 provides the generated trapdoor to the server 20.

The server 20 includes the search unit 22. When the trapdoor (e.g., t-bit trapdoor) is received from the trapdoor generation unit 16, the search unit 22 extracts data (i.e., index (ciphertext)), upper t bits of which are identical to the t bits of the trapdoor, from the stored data (i.e., encrypted indices), and provides the extracted data as search results to the user terminal 10. That is, the search unit 22 of the server 20 may search the stored data for the user's desired data, based on the trapdoor from the trapdoor generation unit 16.

Although the embodiment of the present invention is configured such that the search unit 22 is included in the server 20 (this may be regarded as a DB server), the search unit 22 may be included in any one of an additional computer and an additional storage device, none of which are managed by the user, and then the function of the search unit 22 may be performed by the additional computer or storage device.

In FIG. 1, the decryption unit 18 decrypts the search results (i.e., index (ciphertext)) received from the server 20, and outputs plaintext. That is, the decryption unit 18 may specify the location of a partial interval including desired plaintext by comparing the search results (that is, index (ciphertext)) received from the server 20 with the tag generated using the private key and the cryptographic one-way function f of the advance preparation unit 12. Here, such a comparison is performed between respective bits of the index and the tag in descending order of significance from the Most Significant Bit (MSB) of the index. This procedure may be repeated a number of times corresponding to the bit length of the plaintext, and thus single plaintext may be finally specified to enable decryption.

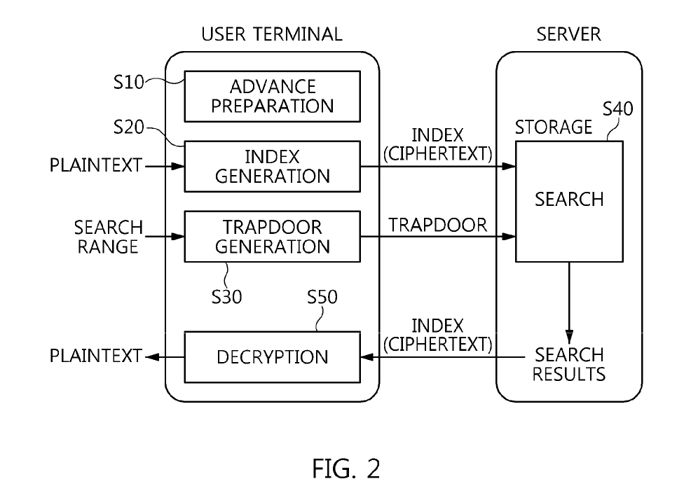

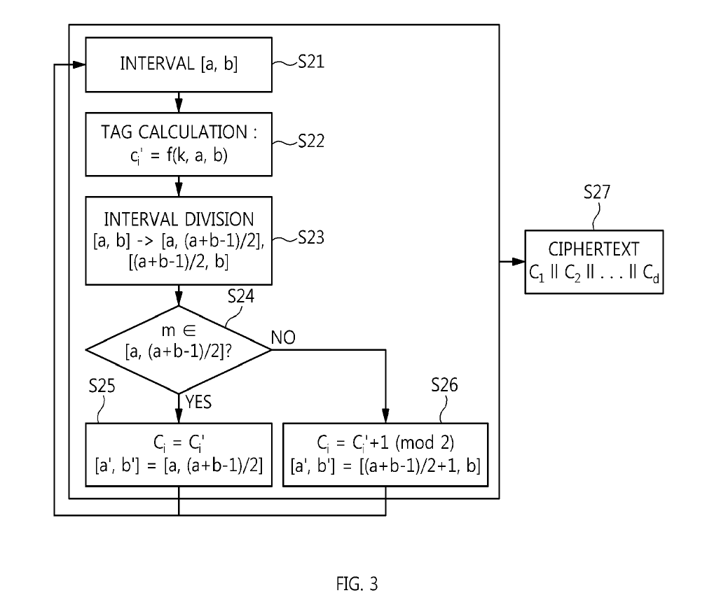

FIG. 2 is a flowchart showing an index generation method, a search method, and a decryption method according to an embodiment of the present invention, and FIG. 3 is a flowchart showing in detail an index generation step shown in FIG. 2.

In the following description, a procedure ranging from advance preparation step S10 to index generation step S20 may be regarded as the index generation method according to an embodiment of the present invention, a procedure ranging from trapdoor generation step S30 to search step S40 may be regarded as the search method according to an embodiment of the present invention, and a procedure ranging from the advance preparation step S10 to decryption step S50 may be regarded as the decryption method according to an embodiment of the present invention.

First, at the advance preparation step S10, the advance preparation unit 12 determines the user's λ-bit private key k and cryptographically secure one-way function f: {0,1}^{λ}×{0,1}^{d}×{0,1}^{d}♯{0,1}, and stores the determined private key k and cryptographically secure one-way function f as private information.

Then, at the index generation step S20, the index generation unit 14 generates an encrypted index to be used for a future range search upon encrypting data. Here, an encrypted index generation procedure by the index generation unit 14 may be performed in the sequence of the following numbered operations:

1. A tag C₁′=f(k, 1, R) for the entire plaintext interval (space) [1, R] is calculated.

2. The entire plaintext interval [1, R] may be divided into two partial intervals having the same size, that is, [1, R/2] and [R/2+1, R]. Of the two partial intervals, a partial interval including plaintext m is selected.

3. If the partial interval including the plaintext m at the above step is [1, R/2], c₁ may be defined as c₁=c₁′, whereas if the partial interval including the plaintext m is [R/2+1, R], c₁ may be defined as c₁=c₁′+1 (mod 2).

4. As at the above step, a interval including plaintext m is assumed to be [a, b] (at step S21 in FIG. 3), and the following procedure is repeated (i=1, 2, . . . , d).

1) A tag cᵢ′=f(k, a, b) for the interval [a, b] is calculated (at step S22 in FIG. 3).

2) The interval [a, b] is divided into two partial intervals [a, (b+a−1)/2] and [(b+a−1)/2+1, b] (at step S23 in FIG. 3). Thereafter, if plaintext m is included in [a, (b+a−1)/2], cᵢ is defined as cᵢ=cᵢ′, whereas if plaintext m is included in [(b+a−1)/2+1, b], cᵢ is defined as cᵢ=cᵢ′+1 (mod 2) (at steps S24 to S26 in FIG. 3).

3) This procedure is repeated using each partial interval including the plaintext m.

5. The encrypted index finally generated via the above-described procedure is composed of c₁∥c₂∥c₃∥ . . . ∥c_{d} (at step S27 in FIG. 3). The encrypted index itself generated in this way becomes ciphertext and is then transmitted to the server 20.

Further, at the trapdoor generation step S30, the trapdoor generation unit 16 generates a trapdoor corresponding to a desired search range. A trapdoor generation procedure may be performed in the sequence of the following numbered operations:

1. It is assumed that a interval [x, y] to be searched by the user is given. Here, for convenience of description, the search interval [x, y] is assumed to be [x, y]=[α(2^{δ})+1, (α+1)(2^{δ})] (where δ=0, 1, . . . , d−1, and α=0, 1, . . . , 2^{d-δ}−1).

2. A tag c₁′=f(k, 1, R) for an initial search interval [1, R] is calculated. Of two partial intervals [1, R/2] and [R/2+1, R] obtained by dividing the initial search interval [1, R], a partial interval including the desired search interval [x, y] is selected.

3. If the interval [x, y] is included in the partial interval [1, R/2], c₁ may be defined as c₁=c₁′, whereas if the interval [x, y] is included in the partial interval [R/2+1, b], c₁ may be defined as c₁=c₁′+1 (mod 2).

4. In this way, of the partial intervals [1, R/2] and [R/2+1, R], a partial interval including [x, y] is defined as [a, b], and the following procedure is repeated (i=1, . . . , d−δ).

1) A tag cᵢ′=f(k, a, b) for the interval [a, b] is calculated, and a partial interval including the desired search interval [x, y] is selected from partial intervals [a,(a+b−1)/2] and [(a+b−1)/2+1, b] obtained by dividing the interval [a, b].

2) If the interval [x, y] is included in [a, (a+b−1)/2], cᵢ may be defined as cᵢ=cᵢ′, whereas if the interval [x, y] is included in [(a+b−1)/2+1, b], cᵢ may be defined cᵢ=cᵢ′+1 (mod 2).

3) This procedure is repeated using each partial interval including the interval [x, y].

5. A trapdoor finally generated via the above-described procedure is composed of c₁∥c₂∥c₃∥ . . . ∥c_{d-δ}. That is, the trapdoor generation unit 16 may be regarded as extracting 1-bit tags for the given interval by a predetermined length. In other words, the trapdoor may be a set of 1-bit tags for the search interval.

The trapdoor finally generated in this way is transmitted to the search unit 22 of the server 20 so as to perform a search in the user's desired search interval. Accordingly, any search interval may be divided and limited to a specific search interval satisfying the above condition, and then a search may be performed.

Thereafter, at the search step S40, the search unit 22 of the server 20 is configured to, when a trapdoor (assumed to be a t-bit trapdoor for convenience of description) is received from the trapdoor generation unit 16, provide an index, the upper t bits of which are identical to the t bits of the given trapdoor, among the stored indices, as search results to the user terminal 10.

Finally, at the decryption step S50, the decryption unit 18 of the user terminal 10 performs decryption. A decryption procedure may be performed in the sequence of the following numbered operations.

1. It is assumed that given search results (ciphertext) indicate c₁∥c₂∥c₃∥ . . . ∥c_{d}.

2. An initial plaintext interval is set to [1, R], and a tag c₁′=f(k, 1, R) is calculated.

3. The initial plaintext interval is divided into two partial intervals [1, R/2] and [R/2+1, R], and the first bit c₁ of the given ciphertext is compared with c₁′. When c₁=c₁′ is satisfied, it means that the plaintext is included in [1, R/2], whereas when c₁≠c₁′ is satisfied, it means that the plaintext is included in [R/2+1, R]. Therefore, depending on the results of the comparison, [a, b] may be set to [1, R/2] or [R/2+1, R].

4. Accordingly, the following procedure is repeated (i=1, 2, . . . , d).

1) A tag cᵢ′=f(k, a, b) for [a, b] is calculated.

2) When cᵢ is compared with cᵢ′, and cᵢ=cᵢ′ is satisfied, this procedure is repeated for a partial interval [a, (a+b−1)/2].

3) In contrast, when c₁≈c₁′ is satisfied, this procedure is repeated for a partial interval [(a+b−1)/2+1, b].

5. When the above procedure is repeated d times, only a single integer is included in the interval [a, b], and the value of the integer is the result of decryption.

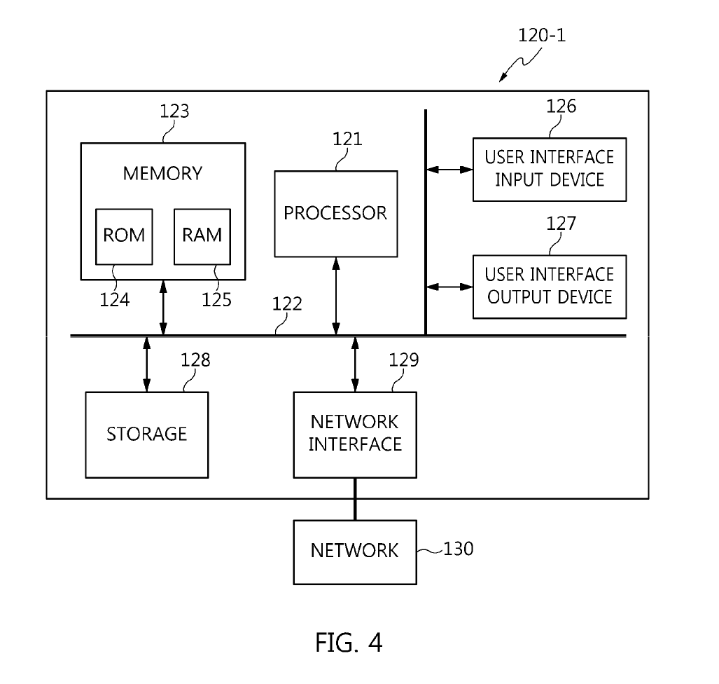

FIG. 4 is an embodiment of the present invention implemented in a computer system.

Refering to FIG. 4, an embodiment of the present invention may be implemented in a computer system, e.g., as a computer readable medium. As shown in in FIG. 4, a computer system 120-1 may include one or more of a processor 121, a memory 123, a user input device 126, a user output device 127, and a storage 128, each of which communicates through a bus 122. The computer system 120-1 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory(RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention having the above configuration, an index for a future range search may be generated upon encrypting data, a trapdoor corresponding to a desired search range may be generated, desired data may be searched for using the index for a search and the trapdoor, and search results may be provided to a user and may be decrypted on the user side, thus enabling an efficient range search for encrypted data to be performed.

Further, unlike an existing searchable encryption technique enabling a range search, decryption may be performed using an index itself.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A decryptable index generation method for a range search, comprising:
generating, by an index generation unit, a tag using a one-way function by receiving information of a interval, in which plaintext is included, and a private key as inputs; and
dividing, by the index generation unit, the interval in which the plaintext is included into a plurality of partial intervals, encrypting information of a partial interval, in which the plaintext is included, by means of the tag, and generating an encrypted index.

2. The decryptable index generation method of claim 1, wherein generating the tag comprises:
receiving the private key and the one-way function prepared by an advance preparation unit; and
for the interval in which the plaintext is included, calculating the tag using both the private key and the one-way function.

3. The decryptable index generation method of claim 1, wherein generating the encrypted index comprises:
dividing the interval in which the plaintext is included into the plurality of partial intervals;
detecting the partial interval, in which the plaintext is included, from the plurality of partial intervals; and
generating the encrypted index by encrypting information of the partial interval, in which the plaintext is included, using the tag.

4. The decryptable index generation method of claim 3, wherein dividing the interval into the plurality of partial intervals is configured to enable a interval division ratio to be randomly adjusted.

5. The decryptable index generation method of claim 1, wherein generating the encrypted index is repeated a number of times corresponding to a bit length of the plaintext.

6. The decryptable index generation method of claim 1, wherein a range search and a decryption operation are enabled using the encrypted index.

7. The decryptable index generation method of claim 1, wherein generating the encrypted index comprises generating a search index shorter than a bit length of the plaintext and providing separate encrypted data, without completing repetitive index generation a number of times corresponding to a bit length of the plaintext.

8. The decryptable index generation method of claim 1, wherein generating the tag is configured to generate the tag at a size of one or more bits.

9. The decryptable index generation method of claim 1, wherein the encrypted index is transmitted to and stored in any one of an additional computer, an additional database server, and an additional storage device, none of which are managed by a user.

10. A search method, comprising:
receiving and storing, by a search unit, an encrypted index;
receiving, by the search unit, a trapdoor generated from a desired search interval using a private key and a one-way function that are used to generate the encrypted index; and
performing, by the search unit, a search by comparing the trapdoor with the encrypted index.

11. The search method of claim 10, wherein the trapdoor is generated based on tags, wherein the tags are generated in such a way that generation of the tags starts at an entire plaintext interval, is performed while the entire plaintext interval is divided, and is repeated until a interval obtained from division is identical to the range search interval.

12. The search method of claim 10, wherein performing the search comprises comparing the trapdoor with the encrypted index, and providing an index, an upper bit string of which is identical to a bit string of the trapdoor, as search results.

13. The search method of claim 10, wherein performing the search is performed by any one of an additional computer, an additional database server, and an additional storage device, none of which are managed by a user.

14. A decryption method, comprising:
receiving, by a decryption unit, an encrypted index;
generating, by the decryption unit, a tag for each plaintext interval using a private key and a one-way function that are used to generate the encrypted index; and
reconstructing, by the decryption unit, plaintext by comparing the encrypted index with the tag and by specifying a partial interval in which the plaintext is included.

15. The decryption method of claim 14, wherein reconstructing the plaintext comprises reconstructing the plaintext into plaintext information by repeating a procedure of dividing a plaintext interval based on information generated from the encrypted index and the one-way function and of estimating a location of the plaintext from intervals obtained from division.

16. The decryption method of claim 15, wherein reconstructing the plaintext further comprises repeating interval division a number of times corresponding to a bit length of the plaintext, upon dividing the plaintext interval.
